(19) United States
(12) Patent Application Publication
(10) Pub. No.: US 2015/0185959 A1
(43) Pub. Date: Jul. 2, 2015

(54) TOUCH LIGHT SHIELDING SUBSTRATE AND TOUCH DISPLAY APPARATUS

(71) Applicant: Chunghwa Picture Tubes, LTD., Taoyuan (TW)

(72) Inventors: Chih-Chieh Chen, Taoyuan County (TW); Chi-Liang Kuo, Taoyuan County (TW); Chia-Hao Kuo, Taipei City (TW)

(73) Assignee: Chunghwa Picture Tubes, LTD., Taoyuan (TW)

(21) Appl. No.: 14/190,112

(22) Filed: Feb. 26, 2014

(30) Foreign Application Priority Data
Dec. 30, 2013 (TW) 102149047

(51) Int. Cl. G06F 3/042

(52) U.S. Cl. CPC G06F 3/0421

(57) ABSTRACT

A touch light shielding substrate including a first substrate, a patterned light shielding layer disposed above the first substrate, first touch sensing units disposed above the first substrate, and second touch sensing units disposed above the first substrate is provided. The patterned light shielding layer has transparent holes arranged in an array. The first touch sensing units and the second touch sensing units are interlaced with each other. The patterned light shielding layer, the first touch sensing units, and the second touch sensing units are located in the same side of the first substrate. The patterned light shielding layer is disposed between the first touch sensing units and the second touch sensing units, so that the first touch sensing units and the second touch sensing units are electrically independent. Moreover, a touch display apparatus including the touch light shielding substrate is also provided.

### CROSS-REFERENCE TO RELATED APPLICATION

This application claims the priority benefit of Taiwan application serial no. 102149047, filed on Dec. 30, 2013. The entirety of the above-mentioned patent application is hereby incorporated by reference herein and made a part of this specification.

### TECHNICAL FIELD

The invention relates to a touch substrate and an optoelectronic apparatus, and more particularly to a touch light shielding substrate and a touch display apparatus.

### RELATED ART

Due to its user-friendly operating interface, the touch panel has been widely applied in various types of electronic devices, particularly mobile electronic devices such as mobile phones and tablet computers. However, in conventional techniques, a touch display apparatus formed by bonding the out-cell touch panel and the display panel has greater thickness, which makes reducing the thickness of the mobile electronic devices difficult. Therefore, an integrated touch display apparatus that integrates the touch panel in the display panel has been proposed.

The integrated touch display apparatus may be categorized by structure into in-cell (in the display panel) and on-cell (on the display panel). For the on-cell, a plurality of first touch sensing units are first fabricated on an inner surface of the color filter substrate of the display panel, and thereafter the color filter substrate is flipped, so that the second touch sensing units interlaced with the first touch sensing units are formed on an outer surface of the color filter substrate. However, during the flipping process, the color filter substrate can be easily scratched or fractured, limiting the yield of the on-cell touch display apparatus. For the in-cell, a black matrix is first formed on the inner surface of the color filter substrate, and then a plurality of photomasks are used above the black matrix to form the first touch sensing units, insulator layers, and the second touch sensing units. Many photomasks are needed with this method, however, resulting in the high cost of the in-cell touch display apparatus.

### SUMMARY OF THE INVENTION

The invention provides a touch light shielding substrate and a touch display apparatus with preferable high yield and low cost.

A touch light shielding substrate of the invention includes a first substrate, a patterned light shielding layer disposed above the first substrate, a plurality of first touch sensing units disposed above the first substrate, and a plurality of second touch sensing units disposed above the first substrate. The patterned light shielding layer has a plurality of transparent holes. The first touch sensing units and the second touch sensing units are interlaced with each other. The patterned light shielding layer, the first touch sensing units, and the second touch sensing units are located in the same side of the first substrate. The patterned light shielding layer is disposed between the first touch sensing units and the second touch sensing units, so that the first touch sensing units and the second touch sensing units are electrically independent.

A touch display apparatus of the invention includes the touch light shielding substrate, a second substrate disposed opposite to the first substrate, a display medium disposed between the touch light shielding substrate and the second substrate, and a plurality of pixel electrodes. The pixel electrodes are arranged in an array on the second substrate and located between the display medium and the second substrate. The transparent holes of the patterned light shielding layer respectively expose the pixel electrodes and cover a region between two neighboring pixel electrodes.

According to an embodiment of the invention, each of the first touch sensing units includes a plurality of first touch sensing patterns and a plurality of first bridge lines serially connected with the first touch sensing patterns. Each of the second touch sensing units is a second touch sensing pattern. The patterned light shielding layer is located between the first bridge lines and the second touch sensing patterns.

According to an embodiment of the invention, the patterned light shielding layer fully covers each of the second touch sensing units. In specifics, each of the second touch sensing patterns includes a plurality of second mesh lines interlaced into a mesh shape, and the second mesh lines form a plurality of second meshes. The bodies of the second touch sensing units, which are a plurality of the second mesh lines, may be fully covered by the patterned light shielding layer.

According to an embodiment of the invention, each of the first touch sensing patterns and each of the second touch sensing patterns have a mesh shape. Each of the first touch sensing patterns has a plurality of first meshes. Each of the second touch sensing patterns has a plurality of second meshes. The first meshes and the second meshes are substantially aligned with a portion of the transparent holes of the patterned light shielding layer respectively. An area of each of the first meshes is greater than or equal to an area of one of the transparent holes aligned with the first mesh. An area of each of the second meshes is greater than or equal to an area of one of the transparent holes aligned with the second mesh.

According to an embodiment of the invention, the first touch sensing patterns and the second touch sensing patterns belong to the same film layer, and the first bridge lines belong to another film layer.

According to an embodiment of the invention, the first bridge lines are located between the patterned light shielding layer and the first substrate.

According to an embodiment of the invention, the patterned light shielding layer has a plurality of contact holes exposing the first bridge lines. The first touch sensing patterns fill the contact holes to electrically contact with the first bridge lines.

According to an embodiment of the invention, the second touch sensing patterns and the first touch sensing patterns are located between the patterned light shielding layer and the first substrate.

According to an embodiment of the invention, the patterned light shielding layer has a plurality of contact holes exposing the first bridge lines, and the first bridge lines fill the contact holes to electrically contact with the first touch sensing patterns.

According to an embodiment of the invention, the touch light shielding substrate or the touch display apparatus further includes a plurality of color filter patterns. The patterned light shielding layer is disposed between the color filter patterns and the first substrate. The transparent holes of the patterned light shielding layer respectively expose the color filter patterns. The patterned light shielding layer fully covers an edge of each of the color filter patterns.

In summary, in the touch light shielding substrate and the touch display apparatus according to an embodiment of the invention, the patterned light shielding layer is located between the first touch sensing units and the second touch sensing units, so that the first touch sensing units and the second touch sensing units are electrically independent. In other words, the touch light shielding substrate and the touch display apparatus according to an embodiment of the invention employs the patterned light shielding layer originally used for preventing the color mixing or light leakage phenomena to serve as the insulator layers between the first touch sensing units and the second touch sensing units. Accordingly, compared to the conventional in-cell, the touch light shielding substrate and the touch display apparatus according to an embodiment of the invention can omit the fabrication of the insulator layers to achieve a preferable low cost. Compared to the conventional on-cell, in the touch light shielding substrate and the touch display apparatus according to an embodiment of the invention, the first touch sensing units and the second touch sensing units are both fabricated in the same side of the first substrate. Therefore, the touch light shielding substrate and the touch display apparatus do not require flipping of the first substrate to fabricate the second touch sensing units, thereby achieving a preferable high yield.

To make the above features and advantages of the present invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1A to FIG. 1D are schematic views illustrating a manufacturing process of a touch light shielding substrate according to an embodiment of the invention.

FIG. 2 is a schematic cross-sectional view of a touch light shielding substrate taken along a section line A-A′ depicted in FIG. 1D.

FIG. 3 is a schematic cross-sectional view of a touch light shielding substrate taken along a section line B-B′ depicted in FIG. 1D.

FIG. 4 is a cross-sectional view of a touch display apparatus according to an embodiment of the invention.

FIG. 5A to FIG. 5D are schematic views illustrating a manufacturing process of a touch light shielding substrate according to another embodiment of the invention.

FIG. 6 is a schematic cross-sectional view of a touch light shielding substrate taken along a section line C-C′ depicted in FIG. 5D.

FIG. 7 is a schematic cross-sectional view of a touch light shielding substrate taken along a section line D-D′ depicted in FIG. 5D.

FIG. 8 is a cross-sectional view of a touch display apparatus according to another embodiment of the invention.

### DETAILED DESCRIPTION OF DISCLOSED EMBODIMENTS

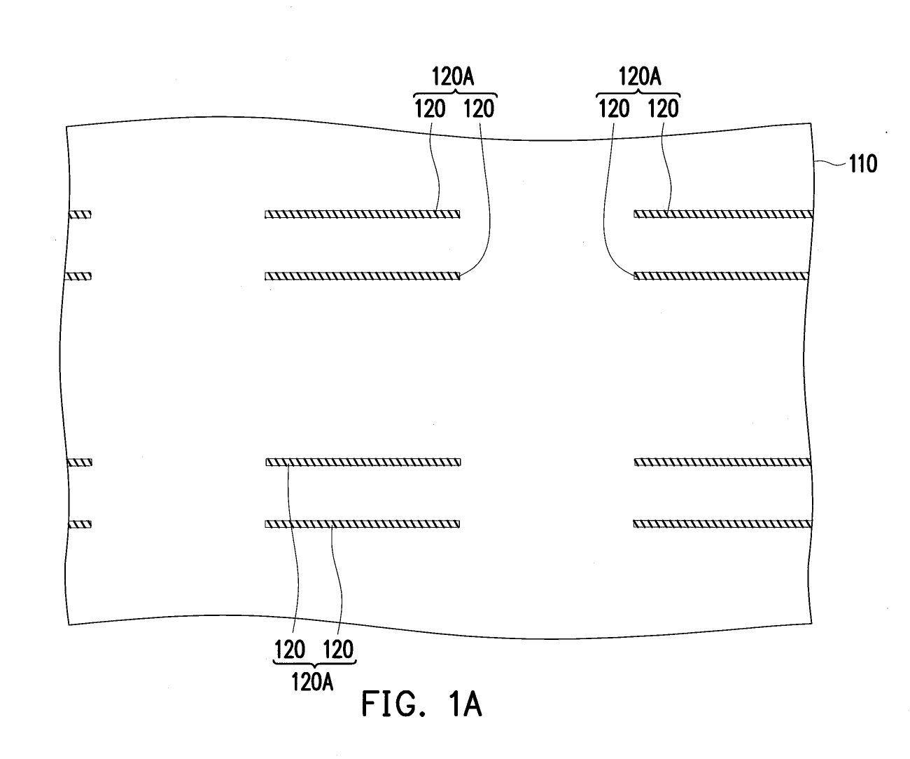

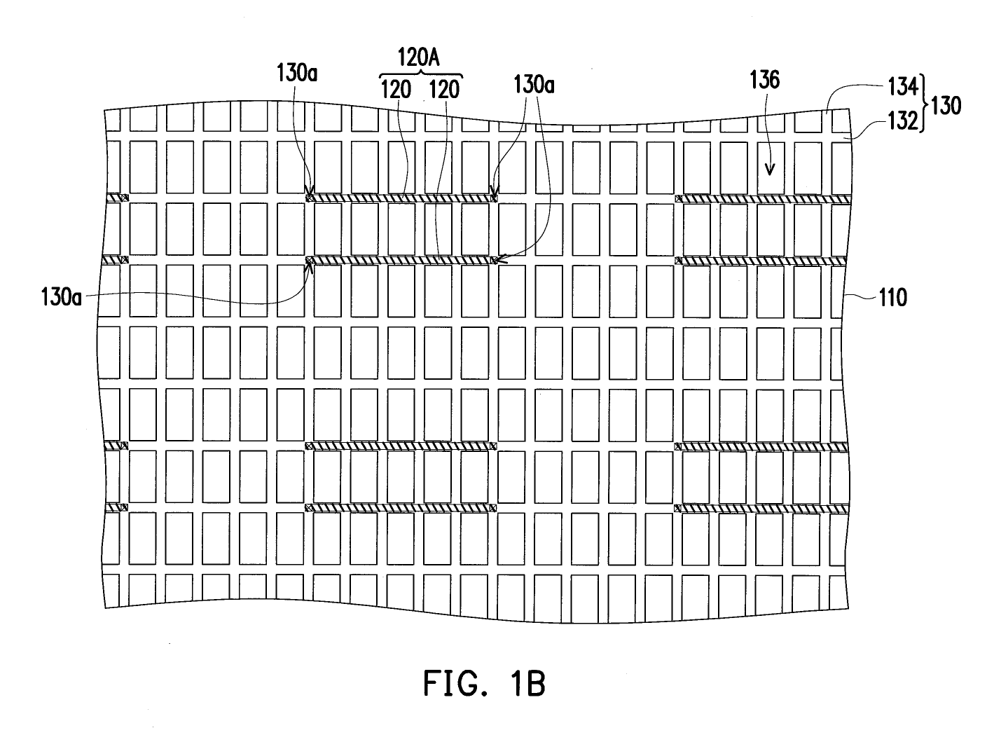

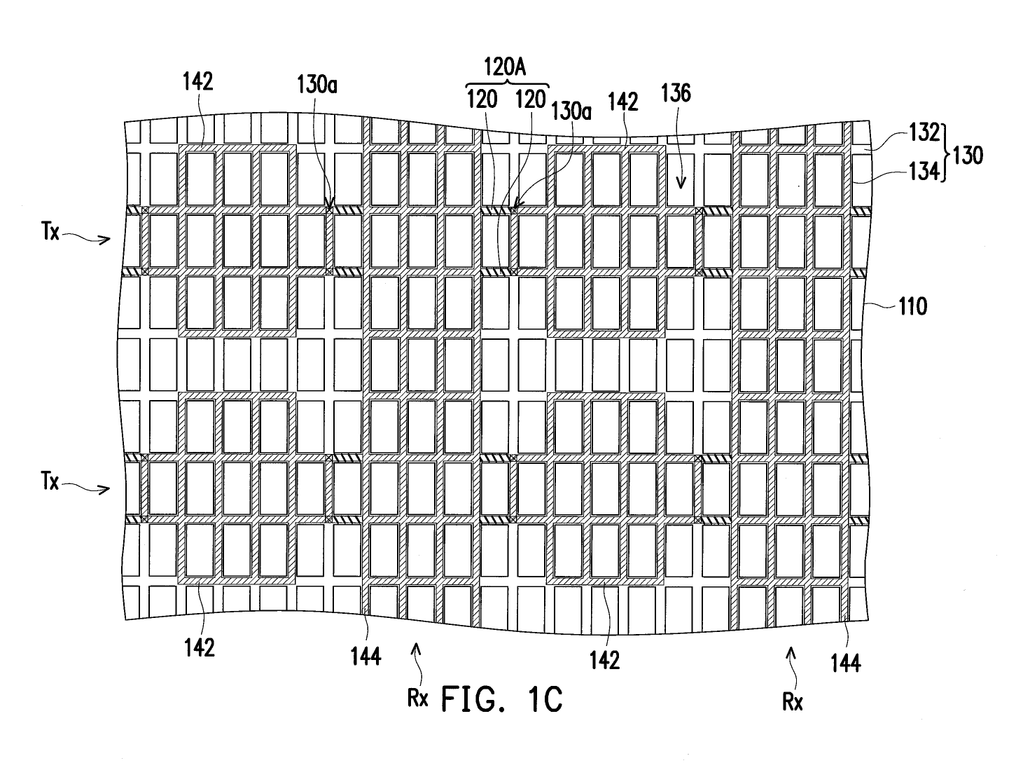

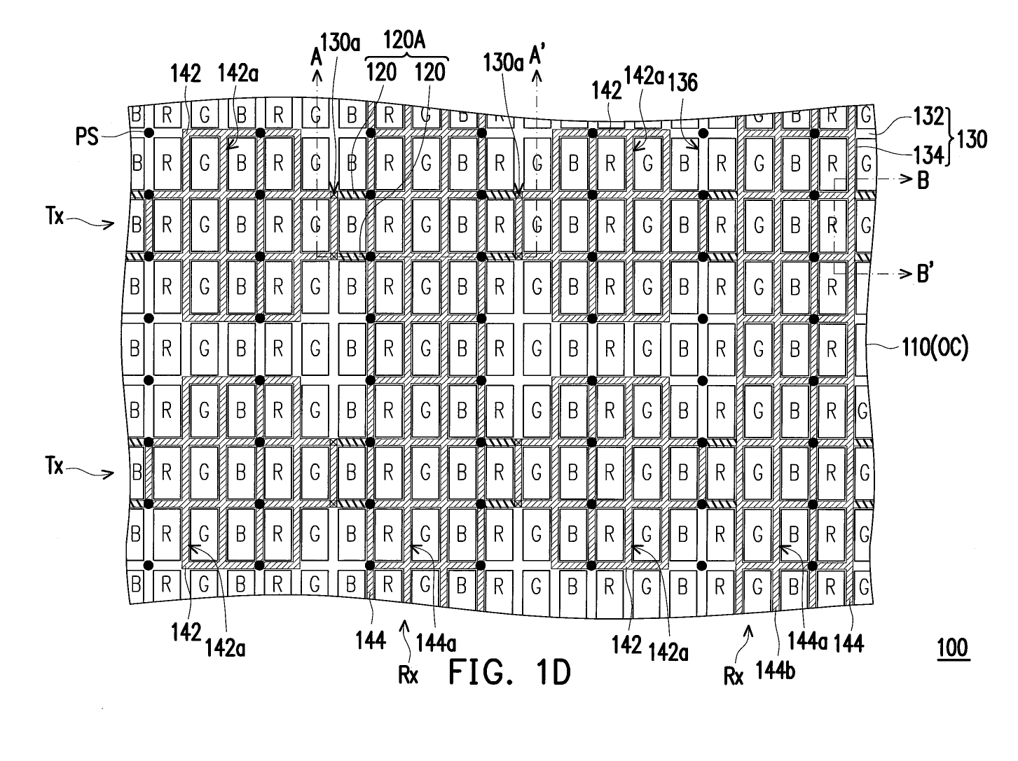

FIG. 1A to FIG. 1D are schematic views illustrating a manufacturing process of a touch light shielding substrate according to an embodiment of the invention. With reference to FIG. 1A, a first substrate 110 is provided. In the present embodiment, the first substrate 110 is a transparent substrate made of glass, plastic, or other suitable materials. Thereafter, a plurality of first bridge lines 120 are formed on the first substrate 110. In the present embodiment, every two first bridge lines 120 may form a bridge line set 120A, and the bridge line sets 120A may be arranged in an array on the first substrate 110. However, the invention is not limited thereto. In other embodiments, a bridge line set 120A may also be formed by a single first bridge line 120 or more than two first bridge lines 120. The number of first bridge lines 120 included in each of the bridge line sets 120A and the arrangement methods of the bridge line sets 120A may be determined according to actual requirements. In the present embodiment, when a user adopts the touch light shielding substrate, the first bridge lines 120 may be the film layer closer to the user in the touch light shielding substrate. Therefore, in order to prevent the user from noticing the first bridge lines 120 and impacting the overall visual effect of the touch light shielding substrate, a material of the first bridge lines 120 is preferably a conductive material with low reflectivity. For example, the material of the first bridge lines 120 may be chromium (Cr), although the invention is not limited thereto. In other embodiments, other suitable conductive materials may be adopted for the first bridge lines 120.

With reference to FIG. 1B, thereafter, a patterned light shielding layer 130 is formed on the first substrate 110. In the present embodiment, the patterned light shielding layer 130 includes a plurality of first insulated light shielding lines 132 parallel to each other, and a plurality of second insulated light shielding lines 134 parallel to each other. The first insulated light shielding lines 132 and the second insulated light shielding lines 134 are interlaced with each other to form a plurality of transparent holes 136. The first insulated light shielding lines 132 cover the first bridge lines 120. It should be noted that, the patterned light shielding layer 130 also has a plurality of contact holes 130a, and the two ends of each of the bridge lines 120 are respectively exposed by two of the contact holes 130a of the patterned light shielding layer 130. The patterned light shielding layer 130 is made of an insulated light shielding material such as black resin, although the invention is not limited thereto. In other embodiments, other suitable insulated materials may be adopted for the patterned light shielding layer 130.

With reference to FIG. 1C, thereafter, a plurality of first touch sensing patterns 142 and a plurality of second touch sensing patterns 144 are arranged in an array on the patterned light shielding layer 130. Each of the second touch sensing patterns 144 is disposed between two neighboring rows of first touch sensing patterns 142. Two neighboring first touch sensing patterns 142 may respectively fill the two contact holes 130a exposing the two opposite ends of the same first bridge line 120, so as to electrically contact the same first bridge line 120 respectively. Accordingly, the first touch sensing patterns 142 can be electrically connected with the bridge line sets 120A interlaced with the first touch sensing patterns 142, and thereby form a plurality of first touch sensing units Tx. The second touch sensing patterns 144 may be viewed as a plurality of second touch sensing units Rx. Each of the second touch sensing units Rx crosses over the patterned light shielding layer 130 on the bridge line sets 120A, so that the first touch sensing units Tx and the second touch sensing units Rx are electrically independent.

In the present embodiment, the first touch sensing patterns 142 and the second touch sensing patterns 144 may be fabricated by the same photomask. In other words, the first touch sensing patterns 142 and the second touch sensing patterns 144 may belong to the same film layer and have the same material. The first touch sensing patterns 142 and the second touch sensing patterns 144 may be made of stacked layers of chromium (Cr), molybdenum (Mo), and aluminum (AL), although the invention is not limited thereto. In other embodiments, other suitable conductive materials may also be adopted for the first touch sensing patterns 142 and the second touch sensing patterns 144.

The first touch sensing units Tx are parallel to each other, the second touch sensing units Rx are parallel to each other, and the first touch sensing units Tx and the second touch sensing units Rx are interlaced with each other. It should be noted that, the interlaced areas of the first touch sensing units Tx and the second touch sensing units Rx (i.e., the location of the first bridge lines 120) are partitioned by the patterned light shielding layer 130 and the second touch sensing units Rx, so that the first touch sensing units Tx and the second touch sensing units Rx are electrically independent. In other words, in the present embodiment, the touch light shielding substrate employs the patterned light shielding layer 130 originally used for preventing the color mixing or light leakage phenomena to serve as the insulator layers between the first touch sensing units Tx and the second touch sensing units Rx. Accordingly, compared to the conventional in-cell frameworks, the touch light shielding substrate of the present embodiment can omit the fabrication of the insulator layers to achieve a preferable low cost. Compared to the conventional on-cell frameworks, in the touch light shielding substrate of the present embodiment, the first touch sensing units Tx and the second touch sensing units Rx are both fabricated in the same side of the first substrate 110. Therefore, the touch light shielding substrate of the present embodiment does not require flipping of the first substrate 110 to fabricate the second touch sensing units Rx, and thereby the touch light shielding substrate of the present embodiment has preferably high yield.

With reference to FIG. 1D, in the present embodiment, a plurality of color filter patterns R, G, and B may then be selectively formed on the first substrate 110. The color filter patterns R, G, and B respectively fill the transparent holes 136 of the patterned light shielding layer 130, so that the touch light shielding substrate further obtains a color filtering function. Thereafter, a planar layer OC may be selectively covered on the color filter patterns R, G, and B. The planar layer OC fully covers the first substrate 110. Besides allowing the touch light shielding substrate 100 to have a planar inner surface, the planar layer OC may further prevent moisture from contacting each film layer between the planar layer OC and the first substrate 110, thereby enhancing the reliability of the touch light shielding substrate 100. Spacers PS may then be selectively formed on the planar layer OC, in order to facilitate the assembly of the touch light shielding substrate 100 with the other substrates. Accordingly, the initial fabrication of the touch light shielding substrate 100 of the present embodiment is completed.

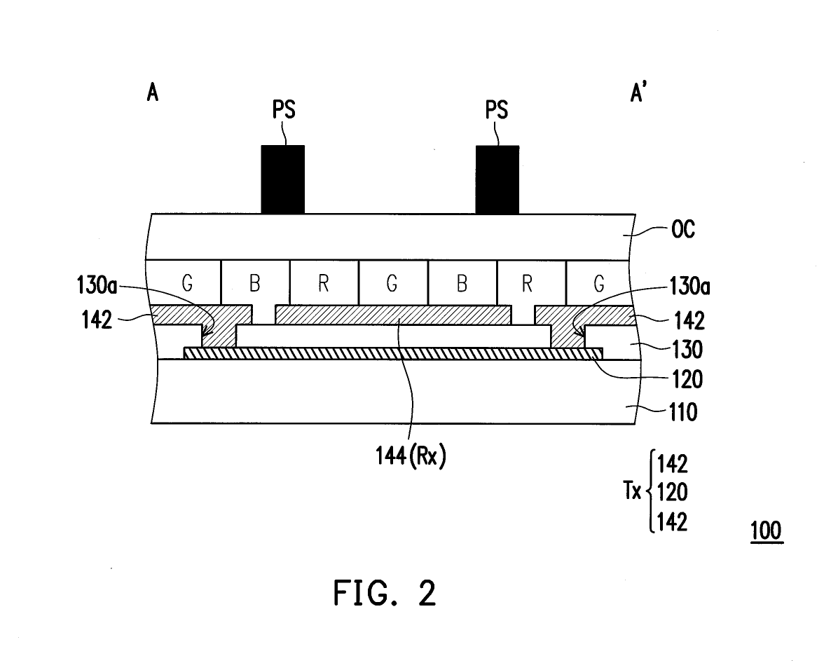

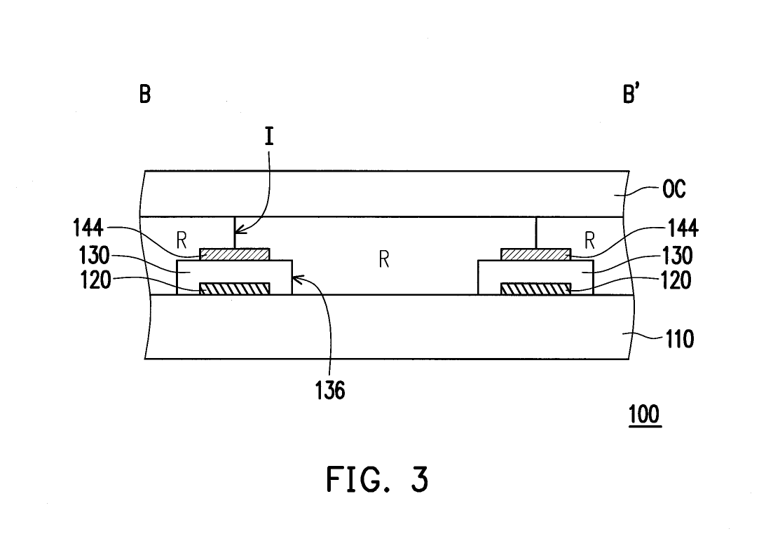

FIG. 2 is a schematic cross-sectional view of a touch light shielding substrate taken along a section line A-A′ depicted in FIG. 1D according to an embodiment of the invention. FIG. 3 is a schematic cross-sectional view of a touch light shielding substrate taken along a section line B-B′ depicted in FIG. 1D. With reference to FIG. 1D, FIG. 2, and FIG. 3, the touch light shielding substrate 100 includes the first substrate 110, the patterned light shielding layer 130 disposed above the first substrate 110 and having the transparent holes 136 arranged in an array, the first touch sensing units Tx disposed above the first substrate 110, and the second touch sensing units Rx disposed above the first substrate 110. The first touch sensing units Tx and the second touch sensing units Rx are interlaced with each other to form a capacitive touch sensing structure. In the present embodiment, the first touch sensing units Tx may be driving lines receiving a driving signal, and the second touch sensing units Rx may be scanning lines sensing electrical signal variations. However, the invention is not limited thereto. In other embodiments, the first touch sensing units Tx may also be employed as sensing lines sensing electrical signal variations, and the second touch sensing units Rx may also be employed as driving lines receiving a driving signal.

The patterned light shielding layer 130, the first touch sensing units Tx, and the second touch sensing units Rx are located in the same side of the first substrate 110. In particular, the patterned light shielding layer 130 is disposed between the first touch sensing units Tx and the second touch sensing units Rx, so that the first touch sensing units Tx and the second touch sensing units Rx are electrically independent. Specifically, in the present embodiment, each of the first touch sensing units Tx includes the first touch sensing patterns 142 and the first bridge lines 120 serially connected with the first touch sensing patterns 142. The first bridge lines 120 may be located between the first substrate 110 and the patterned light shielding layer 130. The patterned light shielding layer 130 is located between the first bridge lines 120 and the second touch sensing patterns 144.

In the present embodiment, other than the areas exposed by the contact holes 130a, each of the first touch sensing units Tx is covered by the patterned light shielding layer 130. In other words, the outer contours of the first insulated light shielding lines 132 of the patterned light shielding layer 130 may encompass the outer contours of each of the first bridge lines 120 of the first touch sensing units Tx, so as to expose the two opposite ends of each of the first bridge lines 120. The outer contours of the patterned light shielding layer 130 may encompass the outer contours of each of the first touch sensing patterns 142 of the first touch sensing units Tx, so as to expose the two areas where each of the first touch sensing patterns 142 overlaps the first bridge lines 120.

From another perspective, each of the first touch sensing patterns 142 may have a mesh shape. Each of the first touch sensing patterns 142 has a plurality of first meshes 142a. The first meshes 142a are substantially aligned with a portion of the transparent holes 136 of the patterned light shielding layer 130 respectively. In the present embodiment, an area of each of the first meshes 142a may be greater than an area of one of the transparent holes 136 aligned with the first mesh 142a. However, the invention is not limited thereto. In other embodiments, the area of each of the first meshes 142a may be equal to the area of one of the transparent holes 136 aligned with the first mesh. That is, in other embodiments, each of the first meshes 142a may be aligned with the corresponding transparent hole 136.

It should be noted that, the bodies of the first touch sensing patterns 142 may be hidden under the patterned light shielding layer 130. Therefore, since the user cannot easily detect the existence of the first touch sensing units Tx, the overall visual effect of the touch light shielding substrate 100 is enhanced. In the present embodiment, the outer contours of the first touch sensing patterns 142 may have a crisscross shape. However, the invention is not limited thereto. In other embodiments, the outer contours of the first touch sensing patterns 142 may be designed to have other suitable shapes.

In the present embodiment, the patterned light shielding layer 130 may fully cover each of the second touch sensing units Rx (i.e., the second touch sensing patterns 144). In specifics, each of the second touch sensing patterns 144 may have a mesh shape. Each of the second touch sensing patterns 144 includes a plurality of second mesh lines 144b interlaced into a mesh shape, and the second mesh lines form a plurality of second meshes 144a. The bodies of the second touch sensing units Rx, which are the second mesh lines 144b, may be fully covered by the patterned light shielding layer 130. The second meshes 144a of each of the second touch sensing patterns 144 are substantially aligned with a portion of the transparent holes 136 of the patterned light shielding layer 130. In the present embodiment, an area of each of the second meshes 144a may be greater than an area of one of the transparent holes 136 aligned with the second mesh. However, the invention is not limited thereto. In other embodiments, the area of each of the second meshes 144a may be equal to the area of one of the transparent holes 136 aligned with the second mesh. That is, in other embodiments, each of the second meshes 144a may be aligned with the corresponding transparent hole 136.

It should be noted that, the bodies of the second touch sensing patterns 144 may be fully hidden under the patterned light shielding layer 130. Therefore, since the user cannot easily detect the existence of the second touch sensing units Rx, the overall visual effect of the touch light shielding substrate 100 is enhanced. In the present embodiment, the outer contours of the second touch sensing patterns 144 may have a strip shape. However, the invention is not limited thereto. In other embodiments, the outer contours of the second touch sensing patterns 144 may be designed to have other suitable shapes.

The touch light shielding substrate 100 of the present embodiment may selectively include the color filter patterns R, G, and B. The patterned light shielding layer 130 is disposed between the first substrate 110 and the color filter patterns R, G, and B. The transparent holes 136 of the patterned light shielding layer 130 respectively expose the color filter patterns R, G, and B. In other words, as shown in FIG. 3, the color filter patterns R may fill the transparent holes 136 of the patterned light shielding layer 130. Furthermore, the patterned light shielding layer 130 covers an edge of each of the color filter patterns R. In the present embodiment, two neighboring color filter patterns R may be contact and have an interface I. The patterned light shielding layer 130 may fully cover the interface I between the two neighboring color filter patterns R. However, the invention is not limited thereto. In other embodiments, the two neighboring color filter patterns R may be separated from each other by a region in between. The patterned light shielding layer 130 may fully cover the region between the two neighboring color filter patterns R.

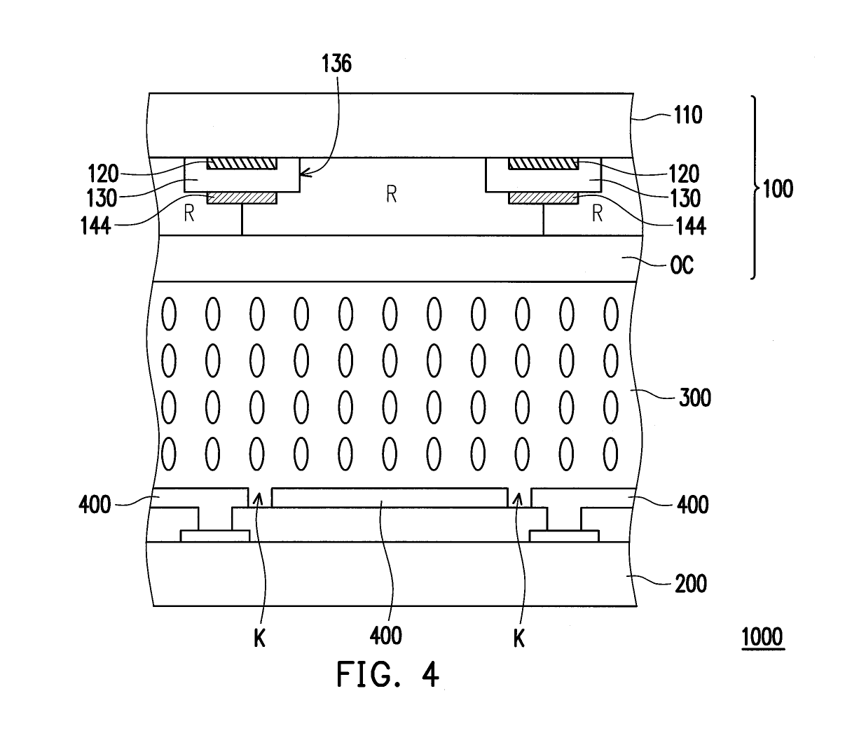

FIG. 4 is a cross-sectional view of a touch display apparatus according to an embodiment of the invention. In particular, FIG. 4 depicts the touch light shielding substrate of FIG. 3. With reference to FIG. 4, a touch display apparatus 1000 includes the touch light shielding substrate 100, a second substrate 200 disposed opposite to the first substrate 110, a display medium 300 disposed between the touch light shielding substrate 100 and the second substrate 200, and a plurality of pixel electrodes 400. The pixel electrodes 400 are arranged in an array on the second substrate 200 and located between the display medium 300 and the second substrate 200. The transparent holes 136 of the patterned light shielding layer 130 respectively expose the pixel electrodes 400 and cover a region K between two neighboring pixel electrodes 400. In the present embodiment, the display medium 300 is liquid crystal, for instance. However, the invention is not limited thereto. In other embodiments, the display medium 300 may also be other suitable materials.

It should be noted that, the invention does not require the touch light shielding substrate 100 to include the color filter patterns R, G, and B. When the touch display apparatus 1000 adopting the touch light shielding substrate 100 needs to have a color display function, the touch display apparatus 1000 may also select to have the color filter patterns R, G, and B disposed between the second substrate 200 and the display medium 300. That is, a so-called color filter on array (COA) structure is formed. Alternatively, the color filter patterns R, G, and B are not adopted, and a display medium capable of emitting multiple colors is employed instead. For example, organic light-emitting diodes (OLEDs) may be used to replace the functions of the color filter patterns R, G, and B. Moreover, the invention does not require the touch display apparatus 1000 to have the color display function. The manufacturers may decide whether to integrate the color filter patterns R, G, and B into the touch display apparatus 1000 according to actual needs.

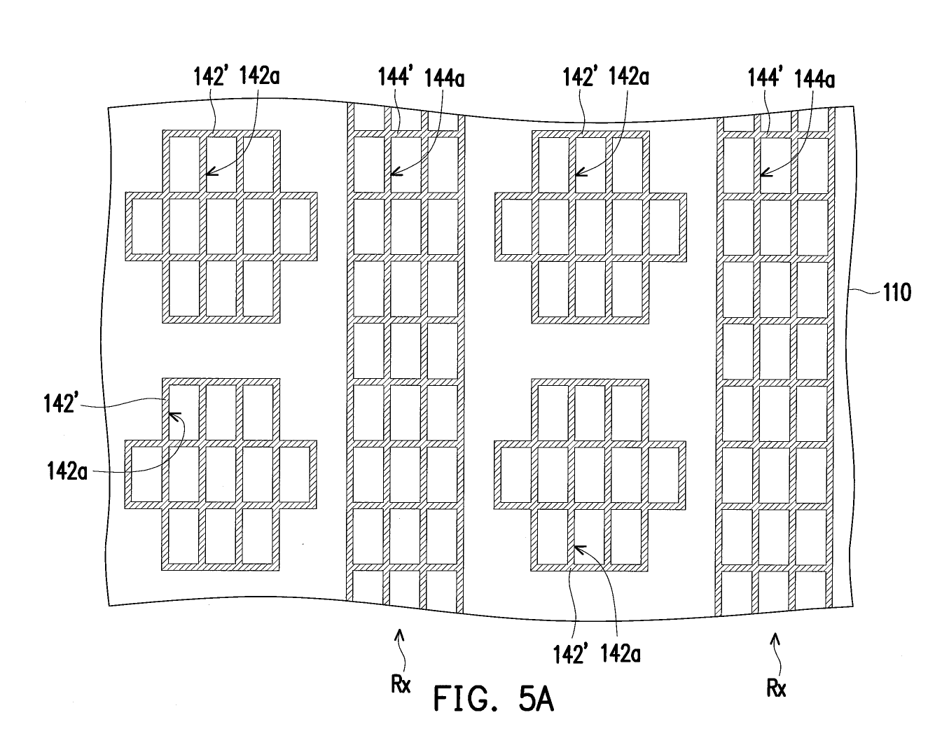

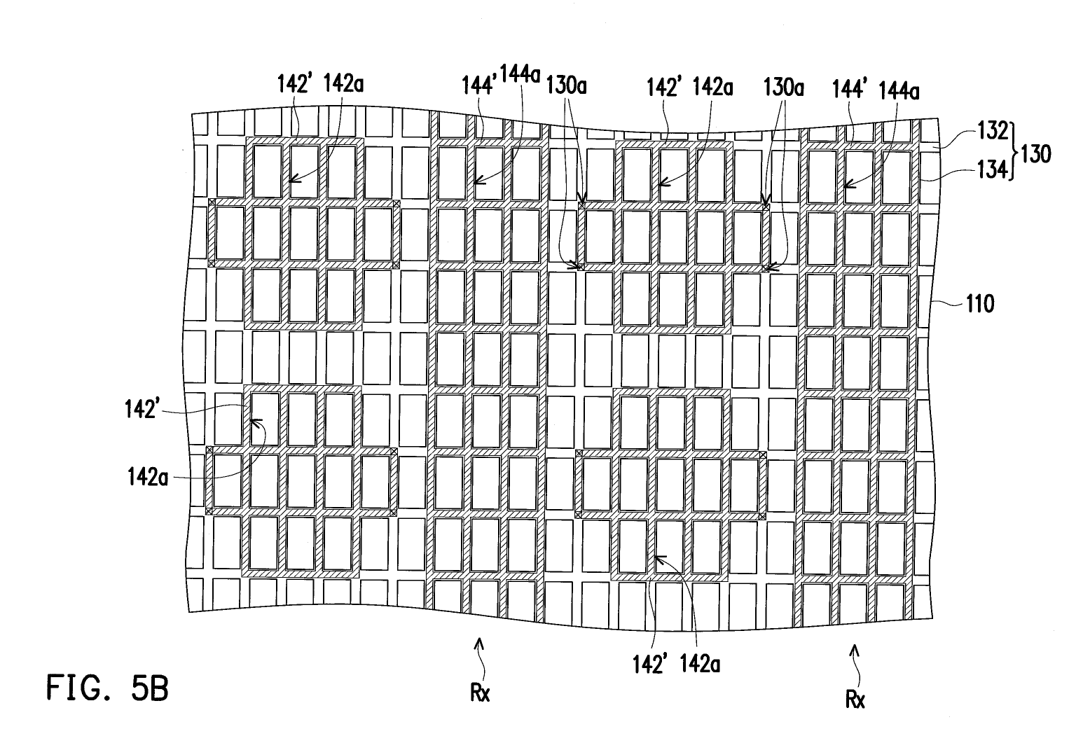

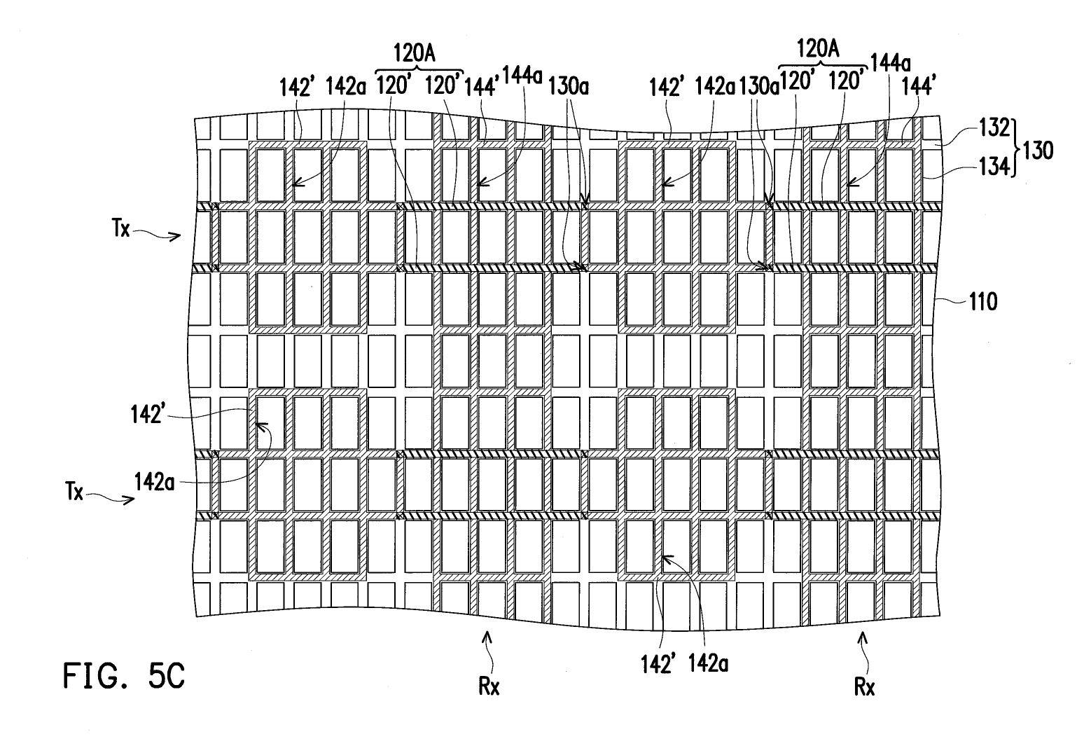

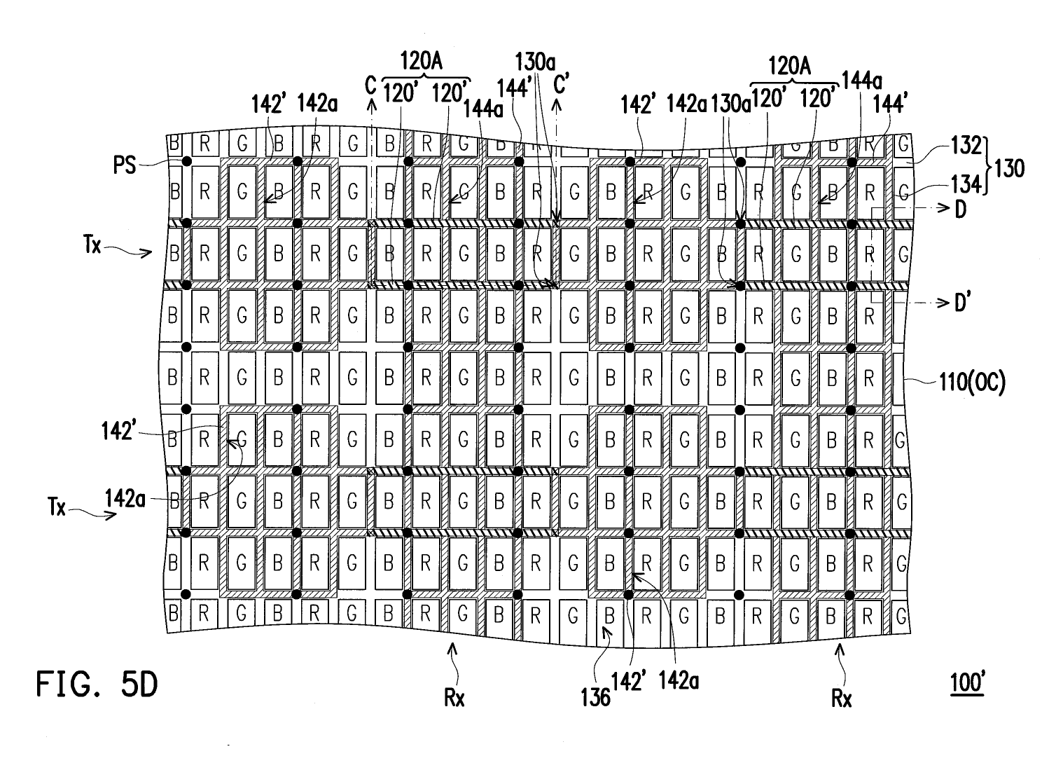

FIG. 5A to FIG. 5D are schematic views illustrating a manufacturing process of a touch light shielding substrate according to another embodiment of the invention. The manufacturing process of the touch light shielding substrate depicted in FIGS. 5A-5D is similar to the manufacturing process of the touch light shielding substrate depicted in FIGS. 1A-1D, and therefore the same or corresponding elements are represented by the same or corresponding reference labels. The differences between the two are discussed below, whereas the similar parts of the two may be referenced by the labels in FIGS. 5A-5D to the earlier description, and therefore further elaboration thereof is omitted.

A difference between the manufacturing process of the touch light shielding substrate depicted in FIGS. 5A-5D and the manufacturing process of the touch light shielding substrate depicted in FIGS. 1A-1D is that, the formation sequence of the first touch sensing patterns 142′ (and the second touch sensing patterns 144′) and the first bridge lines 120′ in FIGS. 5A-5D is the reverse of the formation sequence of the first touch sensing patterns 142 (and the second touch sensing patterns 144) and the first bridge lines 120 in FIGS. 1A-1D. This will be further exemplified below with reference to FIG. 5A to FIG. 5D.

With reference to FIG. 5A, a first substrate 110 is provided. Thereafter, a plurality of first touch sensing patterns 142′ and a plurality of second touch sensing patterns 144′ are arranged in an array on the first substrate 110. The shape and configuration of the first touch sensing patterns 142′ and the first touch sensing patterns 142 are the same. Moreover, the shape and configuration of the second touch sensing patterns 144′ and the second touch sensing patterns 144 are also the same, and thus further elaboration thereof is omitted.

With reference to FIG. 5B, a patterned light shielding layer 130 is then formed on the first substrate 110. The patterned light shielding layer 130 has a plurality of contact holes 130a. The two ends of each of the first touch sensing patterns 142′ are respectively exposed by two of the contact holes 130a of the patterned light shielding layer 130. With reference to FIG. 5C, a plurality of first bridge lines 120′ are formed on the patterned light shielding layer 130. Different from FIG. 1C, the first bridge lines 120′ fill the contact holes 130a to electrically contact with the first touch sensing patterns 142′. The first touch sensing patterns 142 and the first bridge lines 120′ form the first touch sensing units Tx. The second touch sensing patterns 144 may be viewed as the second touch sensing units Rx.

With reference to FIG. 5D, a plurality of color filter patterns R, G, and B may be selectively formed on the first substrate 110. The color filter patterns R, G, and B respectively fill in the transparent holes 136 of the patterned light shielding layer 130, so that the touch light shielding substrate 100′ further obtains a color filtering function. Thereafter, a planar layer OC may be selectively covered on the color filter patterns R, G, and B. The spacers PS may then be selectively formed on the planar layer OC. Accordingly, the initial fabrication of the touch light shielding substrate 100′ of the present embodiment is completed.

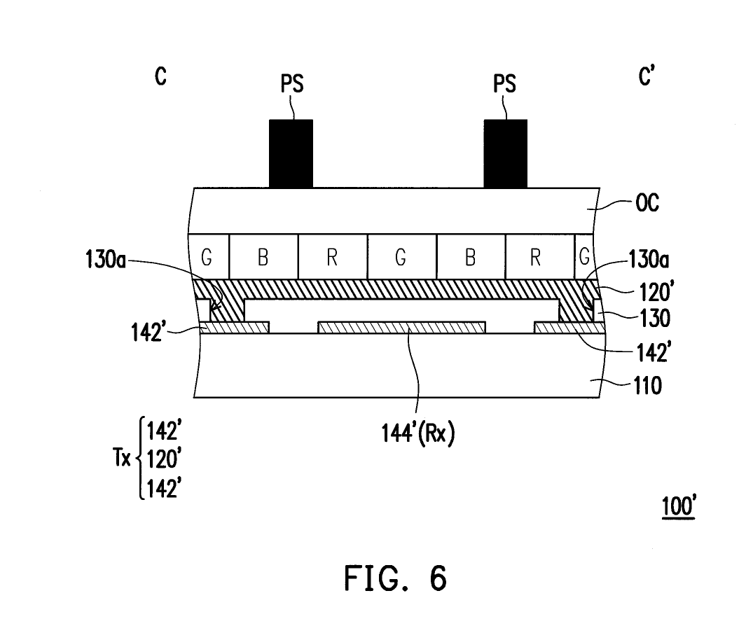

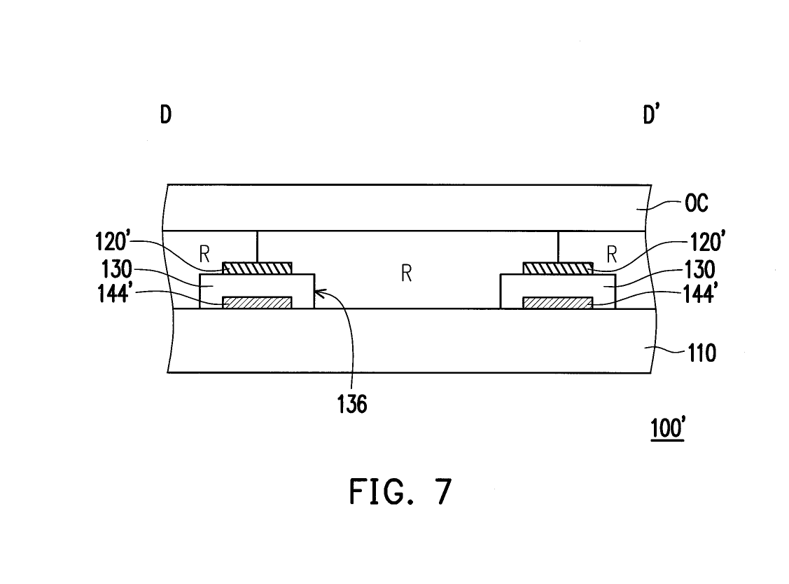

FIG. 6 is a schematic cross-sectional view of a touch light shielding substrate taken along a section line C-C′ depicted in FIG. 5D. FIG. 7 is a schematic cross-sectional view of a touch light shielding substrate taken along a section line D-D′ depicted in FIG. 5D. With reference to FIG. 5D, FIG. 6, and FIG. 7, the touch light shielding substrate 100′ is similar to the touch light shielding substrate 100, and therefore the same or corresponding elements are represented by the same or corresponding reference labels. The differences between the two are discussed below, whereas the similar parts of the two may be referenced by the labels in FIGS. 5D, 6, and 7 to the earlier description, and therefore further elaboration thereof is omitted.

The touch light shielding substrate 100′ includes the first substrate 110, the patterned light shielding layer 130 disposed above the first substrate 110 and having the transparent holes 136 arranged in an array, the first touch sensing units Tx disposed above the first substrate 110, and the second touch sensing units Rx disposed above the first substrate 110. The first touch sensing units Tx and the second touch sensing units Rx are interlaced with each other to form a capacitive touch sensing structure.

The patterned light shielding layer 130, the first touch sensing units Tx, and the second touch sensing units Rx are located in the same side of the first substrate 110. In particular, the patterned light shielding layer 130 is disposed between the first touch sensing units Tx and the second touch sensing units Rx, so that the first touch sensing units Tx and the second touch sensing units Rx are electrically independent. Specifically, in the present embodiment, each of the first touch sensing units Tx includes the first touch sensing patterns 142′ and the first bridge lines 120 serially connected with the first touch sensing patterns 142′. The patterned light shielding layer 130 is located between the first bridge lines 120′ and the second touch sensing patterns 144′. Different from the touch light shielding substrate 100, the second touch sensing patterns 144′ and the first touch sensing patterns 142′ are located between the first substrate 110 and the patterned light shielding layer 130. It should be noted that, the touch light shielding substrate 100′ also employs the patterned light shielding layer 130 originally used for preventing the color mixing or light leakage phenomena to serve as the insulator layers between the first touch sensing units Tx and the second touch sensing units Rx. Accordingly, the touch light shielding substrate 100′ also has preferable low cost and high yield similar to the touch light shielding substrate 100.

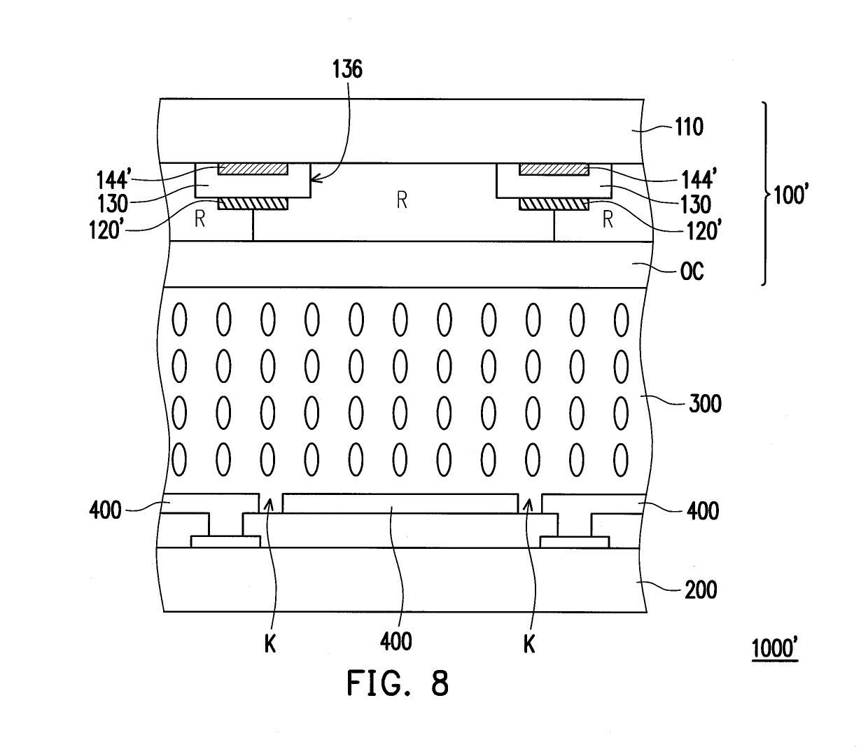

FIG. 8 is a cross-sectional view of a touch display apparatus according to another embodiment of the invention. In particular, FIG. 8 depicts the touch light shielding substrate 100′ of FIG. 7. With reference to FIG. 8, a touch display apparatus 1000′ includes the touch light shielding substrate 100′, the second substrate 200 disposed opposite to the first substrate 110, a display medium 300 disposed between the touch light shielding substrate 100′ and the second substrate 200, and a plurality of pixel electrodes 400. The pixel electrodes 400 are arranged in an array on the second substrate 200 and located between the display medium 300 and the second substrate 200. The transparent holes 136 of the patterned light shielding layer 130 respectively expose the pixel electrodes 400 and cover the region K between two neighboring pixel electrodes 400. The touch light shielding substrate 1000′ can also achieve effects and advantages similar to the touch light shielding substrate 1000, and therefore further elaboration thereof is omitted.

In view of the foregoing, in the touch light shielding substrate and the touch display apparatus according to an embodiment of the invention, the patterned light shielding layer is located between the first touch sensing units and the second touch sensing units, so that the first touch sensing units and the second touch sensing units are electrically independent. In other words, the touch light shielding substrate and the touch display apparatus according to an embodiment of the invention employs the patterned light shielding layer originally used for preventing the color mixing or light leakage phenomena to serve as the insulator layers between the first touch sensing units and the second touch sensing units. Accordingly, compared to the conventional in-cell, the touch light shielding substrate and the touch display apparatus according to an embodiment of the invention can omit the fabrication of the insulator layers to achieve a preferable low cost. Compared to the conventional on-cell frameworks, in the touch light shielding substrate and the touch display apparatus according to an embodiment of the invention, the first touch sensing units and the second touch sensing units are both fabricated in the same side of the first substrate. Therefore, the touch light shielding substrate and the touch display apparatus do not require flipping of the first substrate to fabricate the second touch sensing units, thereby achieving a preferable high yield.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. A touch light shielding substrate, comprising:
a first substrate;
a patterned light shielding layer disposed above the first substrate and having a plurality of transparent holes arranged in an array;
a plurality of first touch sensing units disposed above the first substrate; and
a plurality of second touch sensing units disposed above the first substrate and interlaced with the first touch sensing units, wherein the patterned light shielding layer, the first touch sensing units, and the second touch sensing units are located in a same side of the first substrate, and the patterned light shielding layer is disposed between the first touch sensing units and the second touch sensing units, so that the first touch sensing units and the second touch sensing units are electrically independent.

2. The touch light shielding substrate according to claim 1, wherein each of the first touch sensing units comprises a plurality of first touch sensing patterns and a plurality of first bridge lines serially connected with the first touch sensing patterns, each of the second touch sensing units is a second touch sensing pattern, and the patterned light shielding layer is located between the first bridge lines and the second touch sensing patterns.

3. The touch light shielding substrate according to claim 2, wherein the patterned light shielding layer fully covers each of the second touch sensing units.

4. The touch light shielding substrate according to claim 3, wherein each of the first touch sensing patterns and each of the second touch sensing patterns have a mesh shape, each of the first touch sensing patterns has a plurality of first meshes, each of the second touch sensing patterns has a plurality of second meshes, the first meshes and the second meshes are aligned with a portion of the transparent holes of the patterned light shielding layer respectively, an area of each of the first meshes is greater than or equal to an area of one of the transparent holes aligned with the first mesh, and an area of each of the second meshes is greater than or equal to an area of one of the transparent holes aligned with the second mesh.

5. The touch light shielding substrate according to claim 2, wherein the first touch sensing patterns and the second touch sensing patterns belong to a same film layer, and the first bridge lines belong to another film layer.

6. The touch light shielding substrate according to claim 2, wherein the first bridge lines are located between the patterned light shielding layer and the first substrate.

7. The touch light shielding substrate according to claim 6, wherein the patterned light shielding layer has a plurality of contact holes exposing the first bridge lines, and the first touch sensing patterns fill the contact holes to electrically contact with the first bridge lines.

8. The touch light shielding substrate according to claim 2, wherein the second touch sensing patterns and the first touch sensing patterns are located between the patterned light shielding layer and the first substrate.

9. The touch light shielding substrate according to claim 8, wherein the patterned light shielding layer has a plurality of contact holes exposing the first touch sensing patterns, and the first bridge lines fill the contact holes to electrically contact with the first touch sensing patterns.

10. The touch light shielding substrate according to claim 1, further comprising:
a plurality of color filter patterns, the patterned light shielding layer being disposed between the color filter patterns and the first substrate, the transparent holes of the patterned light shielding layer respectively exposing the color filter patterns, and the patterned light shielding layer fully covers an edge of each of the color filter patterns.

11. A touch display apparatus, comprising:
a touch light shielding substrate, comprising:
a first substrate;
a patterned light shielding layer disposed above the first substrate and having a plurality of transparent holes arranged in an array;
a plurality of first touch sensing units disposed above the first substrate; and
a plurality of second touch sensing units disposed above the first substrate and interlaced with the first touch sensing units, wherein the patterned light shielding layer, the first touch sensing units, and the second touch sensing units are located in a same side of the first substrate, and the patterned light shielding layer is disposed between the first touch sensing units and the second touch sensing units, so that the first touch sensing units and the second touch sensing units are electrically independent;
a second substrate disposed opposite to the first substrate;
a display medium disposed between the touch light shielding substrate and the second substrate; and
a plurality of pixel electrodes arranged in an array on the second substrate and located between the display medium and the second substrate, the transparent holes of the patterned light shielding layer respectively exposing the pixel electrodes and covering a region between two neighboring pixel electrodes.

12. The touch display apparatus according to claim 11, wherein each of the first touch sensing units comprises a plurality of first touch sensing patterns and a plurality of first bridge lines serially connected with the first touch sensing patterns, each of the second touch sensing units is a second touch sensing pattern, and the patterned light shielding layer is located between the first bridge lines and the second touch sensing patterns.

13. The touch display apparatus according to claim 12, wherein the patterned light shielding layer fully covers each of the second touch sensing units.

14. The touch display apparatus according to claim 13, wherein each of the first touch sensing patterns and each of the second touch sensing patterns have a mesh shape, each of the first touch sensing patterns has a plurality of first meshes, each of the second touch sensing patterns has a plurality of second meshes, the first meshes and the second meshes are aligned with a portion of the transparent holes of the patterned light shielding layer respectively, an area of each of the first meshes is greater than or equal to an area of one of the transparent holes aligned with the first mesh, and an area of each of the second meshes is greater than or equal to an area of one of the transparent holes aligned with the second mesh.

15. The touch display apparatus according to claim 12, wherein the first touch sensing patterns and the second touch sensing patterns belong to a same film layer, and the first bridge lines belong to another film layer.

16. The touch display apparatus according to claim 12, wherein the first bridge lines are located between the patterned light shield layer and the first substrate.

17. The touch display apparatus according to claim 16, wherein the patterned light shielding layer has a plurality of contact holes exposing the first bridge lines, and the first touch sensing patterns fill the contact holes to electrically contact with the first bridge lines.

18. The touch display apparatus according to claim 12, wherein the second touch sensing patterns and the first touch sensing patterns are located between the patterned light shielding layer and the first substrate.

19. The touch display apparatus according to claim 18, wherein the patterned light shielding layer has a plurality of contact holes exposing the first bridge lines, and the first bridge lines fill the contact holes to electrically contact with the first touch sensing patterns.

20. The touch display apparatus according to claim 11, further comprising:
a plurality of color filter patterns, the patterned light shielding layer being disposed between the color filter patterns and the first substrate, the transparent holes of the patterned light shielding layer respectively exposing the color filter patterns, and the patterned light shielding layer fully covers an edge of each of the color filter patterns.
